(19) United States
(12) Patent Application Publication
(10) Pub. No.: US 2009/0043473 A1
(43) Pub. Date: Feb. 12, 2009

(54) APPARATUS FOR ESTIMATING ROAD SURFACE GRADIENT AND VEHICULAR CONTROL APPARATUS USING THE SAME

(75) Inventors: Yasuhiro NAKAI, Kariya-shi (JP); Hajime KUMABE, Kariya-shi (JP); Shotaro FUKUDA, Oobu-shi (JP); Satoshi NIWA, Nagoya (JP); Masayoshi TAKEDA, Kariya-shi (JP); Yukio MORI, Kariya-shi (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/188,575

(22) Filed: Aug. 8, 2008

(30) Foreign Application Priority Data
Aug. 10, 2007 (JP) 2007-209245

(51) Int. Cl. G06F 7/00

(52) U.S. Cl. 701/70

(57) ABSTRACT

An apparatus is provided to estimate a gradient of a road surface on which a vehicle travels. The apparatus comprises acquisition, estimation, and compensation members. The acquisition member acquires at least one of acceleration of the vehicle calculated on changes in a travel speed of the vehicle and acceleration sensed from a force applied to the vehicle. The estimation means estimates the gradient of the road surface based on the acquired acceleration. The compensation member compensates the acquired acceleration in terms of influence of noise superposed on the acceleration, depending on an operational condition of the vehicle. The compensated acceleration is used by the estimation. The compensation is carried out by cutting off the noise by a filter, for example.

### CROSS-REFERENCE TO RELATED APPLICATION

This application is based on and claims the benefit of priority from earlier Japanese Patent Application No. 2007-209245 filed Aug. 10, 2007, the description of which is incorporated herein by reference.

### BACKGROUND OF THE INVENTION

1. Technical Field of the Invention

The present invention relates to an apparatus for estimating a road surface gradient using the output of at least one of acceleration calculating means for calculating acceleration of a vehicle based on the travel speed of the vehicle, and acceleration sensing means for sensing acceleration based on the force applied to the means per se. The present invention also relates to an apparatus and system for controlling vehicles, which is equipped with the apparatus for estimating the road surface gradient.

2. Background Art

This type of control apparatus is disclosed, for example, in Japanese Patent Laid-Open No. 4-303029. The apparatus suggested in this literature estimates the gradient of a road surface using the output of acceleration sensing means (acceleration sensor) that senses acceleration based on the force applied to the acceleration sensor per se, and using the acceleration calculated based on the time derivative of a detection value derived from a vehicle-speed sensor. The acceleration sensor senses acceleration based on the force applied to the acceleration sensor per se. Specifically, the acceleration sensor senses so a composite acceleration resulting from a gravitational acceleration applied to the vehicle when the road surface the vehicle travels on has a gradient, and a vehicle acceleration induced by the change in the travel speed of the vehicle. The apparatus disclosed in this literature estimates the road surface gradient the vehicle travels on, using both the output of the acceleration sensor and the acceleration calculated from the detection value of the vehicle-speed sensor.

Various disturbances may be mingled in the acceleration calculated from a detection value of the vehicle-speed sensor and the output of the acceleration sensor. For example, in accelerating a vehicle, the vehicle tilts backward (squats), and in decelerating the vehicle, the vehicle tilts forward (dives). In other words, in accelerating and decelerating a vehicle, the vehicle will receive a force in the direction of the rotation angle (pitch angle) about its lateral axis defined as a geometrical axis passing through the gravity center. This force will eventually be sensed by the acceleration sensor. Accordingly, the force applied in the direction of the pitch angle of the vehicle will be a factor that would cause an error in estimating the road surface gradient.

In the case where the vehicle is equipped with a staged transmission system, the vehicle will have a transmission shock when the gear ratio switch control is effected. The transmission shock may influence the output of the acceleration sensor and the detection value of the vehicle-speed sensor. Therefore, when the gear ratio switch control is effected, the accuracy in estimating the road surface gradient may be deteriorated.

Further, in the case where the vehicle is vibrated by the rough road surface the vehicle travels on, noise will be superposed on both of the detection value of the vehicle-speed sensor and the output of the acceleration sensor. This noise will also be a factor for deteriorating the accuracy in estimating the road surface gradient.

A filtering process may be used to remove the components of the noise from the detection value of the vehicle-speed sensor and the output of the acceleration sensor. However, use of the filtering process may cause delay in the detection value and the output, with respect to the actual ones. Accordingly, the estimation accuracy may be deteriorated in the case where, for example, the road surface gradient changes.

Besides the apparatus for estimating road surface gradient as explained above, some apparatuses may estimate the road surface gradient based at least on the output of either one of the acceleration sensor and the vehicle-speed sensor. Such apparatuses are basically in the common situation that adequate estimation of the road surface gradient is difficult.

### SUMMARY OF THE INVENTION

The present invention has been made in order to resolve the problems explained above, and has as its object to provide an apparatus for estimating road surface gradient, which is able to more adequately estimate a road surface gradient based on the output of either one of acceleration calculating means for calculating acceleration of a vehicle based on the travel speed of the vehicle, and acceleration sensing means for sensing acceleration based on the force applied to the acceleration sensing means per se.

In order to achieve the above object, as one aspect of the present invention, there is provided a n apparatus for estimating a gradient of a road surface on which a vehicle travels. The estimating apparatus comprises acquisition means for acquiring at least one of acceleration (acceleration caused in the longitudinal direction of the vehicle) of the vehicle calculated on changes in a travel speed of the vehicle and acceleration sensed from a force applied to the vehicle; estimation means for estimating the gradient of the road surface based on the acceleration acquired by the acquisition means; and compensation means for compensating the acceleration acquired by the acquisition means in terms of influence of noise superposed on the acceleration, depending on an operational condition of the vehicle, the compensated acceleration being provided to the estimation means.

In the above invention, the influence of the noises superposed on the output of at least one of the above means is compensated according to the operational Condition of the vehicle. Thus, in the case where the change in the gradient of a road surface (roadbed or roadway) becomes larger, priority can be given to the responsiveness over the noise removal. On the other hand, in a vehicle equipped with a staged transmission system, for example, appropriate removal can be performed targeting the noises induced by the transmission shock that would be caused by the switch control for gear ratio of the staged transmission system. Further, the noises induced by the squatting or diving of the vehicle during acceleration or deceleration of the vehicle, for example, can also be removed.

Preferably, the compensation means comprises filtering means for cutting off at least one of the noise superposed in the acceleration provided to the estimation means and the noise superposed in a signal used by the estimation means, the signal being related to the acceleration provided to the estimation means, the filtering means having a plurality of filtering modes selectably set, and changing means for changing the filtering modes of the filtering means depending on the operational condition of the vehicle.

As the frequency permeated through the filtering means is lowered, the delay caused by the filtering means will be larger. In this regard, the above invention can perform appropriate filtering process according to the operational conditions of the vehicle, owing to the variably set selective permeating modes of the filtering means. For example, in the operational conditions where the responsiveness is an issue in the estimation process of the road surface gradient, the responsiveness can be enhanced by reducing the filtering effects. In particular, in the operational conditions where noise removal is an issue, the noises can be appropriately removed by increasing the filtering so effects.

The above invention may further be provided with gradient equivalence calculating means for calculating an amount equivalent to the road surface gradient, based on the output of at least one of the above means. Also, the amount equivalent to the road surface gradient may be inputted to the filtering means.

It is also preferred that the apparatus further comprises amount calculating means for calculating an amount corresponding to the gradient based on the acceleration provided by the acquisition means; and provisional estimation means for provisionally estimating, as the operational condition of the vehicle, changes in the gradient of the road surface based on the amount calculated by the amount calculating means, wherein the changing means the filtering modes of the filtering means depending on the changes in the gradient provisionally estimated by the provisional estimation means.

In the above invention, the selective permeating modes of the filtering means can be variably set according to the change in the road surface gradient. Thus, in the case where the responsiveness is desired to be enhanced in the estimation of the road surface gradient in spite of changing road surface gradient, the responsiveness can be enhanced by increasing the frequencies permeated through the filtering means.

The provisional estimation means may comprise filtering means for filtering the amount from the amount calculating means and means for estimating the changes in the gradient based on a difference between a filtered result of the amount by the filtering means and the amount from the amount calculating means.

A signal applied with the filtering process will have a delay peculiar to the filtering process. Accordingly, it is considered that, the larger the change in the road surface gradient is, the larger the amount of delay will be between the output applied with the filtering process and the output not applied with the filtering process. The above invention has put a focus on this point and enables estimation of the change in the road surface gradient, based on the difference between the outputs applied with and not applied with the filtering process.

It is also preferred that the vehicle comprises a motive power generation apparatus having an output shaft transmitting a motive power and a staged transmission apparatus, whose gear ratios are switchable, transmitting the motive power from the output shaft to drive wheels of the vehicle, and the changing means is configured to lower an upper limit of a cutting-off frequency of the filtering during a switchover control of the gear ratios at the stated transmission apparatus.

In the staged transmission system, the gear ratio is discontinuously changed by effecting switch control for gear ratio. Also, under the switch control for gear ratio, the motive power transmission from the output shaft of the motive power generator to the side of the drive wheels is temporarily interrupted and then resumed. Thus, transmission shock may be caused by the switch control for gear ratio of the staged transmission system. The transmission shock can be the cause of noises in the estimation of the road surface gradient. Focusing on this point, the above invention is adapted to reduce the upper limit of the frequency during the switch control for gear ratio, so that the influence quality of the transmission shock can be appropriately be suppressed in the estimation of the road surface gradient.

In another preferred configuration, the acquisition means comprises at least the means for sensing the acceleration based on the force applied to the vehicle and the vehicle comprise a motive power generation apparatus that generates a motive power for the travel thereof. In this case, the apparatus further comprises means for estimating a pitch angle of a pitch motion of the vehicle based on torque generated by the motive power generation apparatus, and means for correcting the gradient of the road surface based on the estimated pitch angle.

It is true that vehicles will squat when accelerated and will dive when decelerated. During the acceleration or deceleration, the influence of the squatting or diving may be mingled, in the form of noises, into the output of the acceleration sensing means. Thus, the present invention is adapted to estimate the amount of rotation in the direction of the rotation angle (pitch angle) of the lateral axis of the vehicle, so that the influence of the pitch angle can be appropriately removed from the estimation of the road surface gradient. The reason why the pitch angle is estimated based on the torque generated by the motive power generator is that the acceleration or the deceleration of the vehicle is caused by the torque outputted from the motive power generator.

As another mode, the present invention provides an apparatus for controlling acceleration of a vehicle which travels on a road surface. The apparatus comprises acquisition means for acquiring at least one of acceleration of a vehicle calculated on changes in a travel speed of the vehicle and acceleration sensed from a force applied to the vehicle; estimation means for estimating a gradient of the road surface based on the acceleration acquired by the acquisition means; compensation means for compensating the acceleration acquired by the acquisition means in terms of influence of noise superposed on the acceleration, depending on an operational condition of the vehicle, the compensated acceleration being provided to the estimation means; and feedforward control means for feedforward controlling the acceleration of the vehicle based on a target acceleration and the gradient of the road surface estimated by the estimation means.

In feedforward-controlling the actual vehicle speed according to the requested acceleration, it is preferred to obtain information on the forces applied to the vehicle. One of such forces is the gravity applied in the travel direction of the vehicle, which gravity is applied by the fact that the road surface is inclined. The calculation accuracy of the gravity in the travel direction relies on the estimation accuracy of the road surface gradient. Accordingly, the accuracy of the feedforward control also relies on the estimation accuracy of the road surface gradient. In so this regard, the present invention is adapted to appropriately estimate the road surface gradient to appropriately effect the feedforward control. As a result, the travel conditions of the vehicle can be improved, and thus the ride quality can also be improved.

### BRIEF DESCRIPTION OF THE DRAWINGS

In the accompanying drawings:

FIG. 1 illustrates a general configuration of a vehicle control system, according to an embodiment of the present invention;

FIG. 2 is a block diagram illustrating the processes concerning automatic travel control, according to the embodiment;

FIG. 3 is a block diagram illustrating in detail the processes performed by a front-rear direction controller, according to the embodiment;

FIG. 4 is a flow diagram illustrating a procedure performed by a jerk limiting reference model setter of the front-rear direction controller;

FIG. 5A is a flow diagram illustrating a procedure performed by a reference model setter of the front-rear direction controller;

FIG. 5B is a diagram illustrating response characteristics of actual vehicle;

FIG. 6 is a flow diagram illustrating a procedure performed by a feedback controller of the front-rear direction controller;

FIG. 7 is a flow diagram illustrating a procedure performed by a feedforward controller of the front-rear direction controller;

FIG. 8 is a flow diagram illustrating a procedure performed by a distributor of the front-rear direction controller; and

FIG. 9 is a block diagram illustrating a procedure for estimating road surface gradient, according to the embodiment.

### DETAILED DESCRIPTION OF THE PREFERRED EMBODIMENTS

With reference to the accompanying drawings, hereinafter will be described an embodiment of the present invention, in which an apparatus for estimating the gradient of a road surface (roadbed or roadway) is applied to a vehicle control system for controlling acceleration of vehicles.

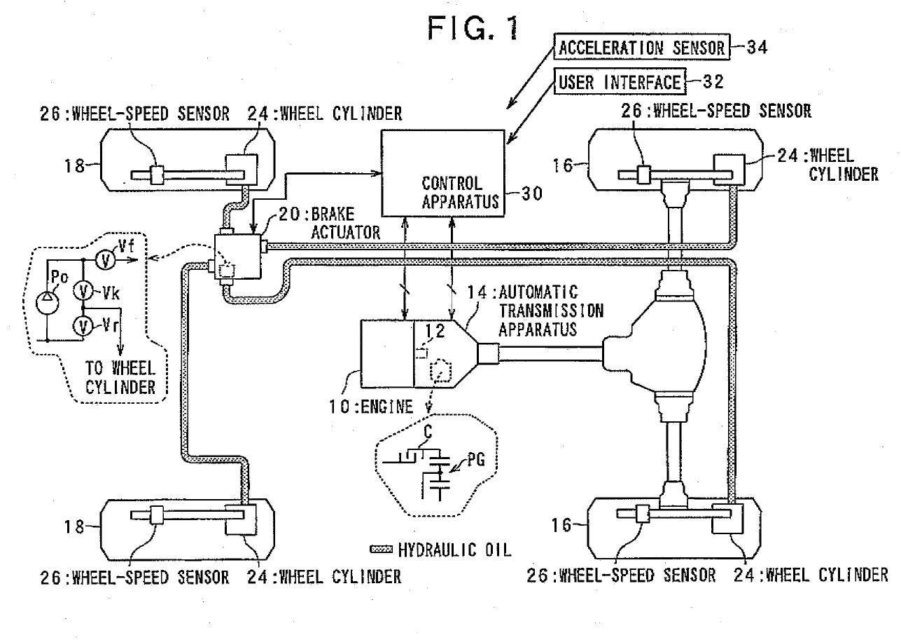

FIG. 1 illustrates a general configuration of the vehicle-control system including the road surface gradient estimating apparatus, which are according to the embodiment.

An engine 10, a gasoline powered internal combustion engine, includes a crank shaft 12 to which an automatic transmission system 14 is connected. The automatic transmission system 14 is provided with a torque converter and a planetary gear automatic transmission. In the planetary gear automatic transmission, any of a plurality of power transmission paths formed by planetary gears PG is selected, depending on the engagement conditions of a clutch C and a brake (not shown) as friction elements. The planetary gear automatic transmission is adapted to realize a gear ratio according to the selected power transmission path. The torque of the crank shaft 12 of the engine 10 is changed by the automatic transmission system 14 and then transmitted to drive wheels 16.

The drive wheels 16 and idler wheels 18 can be imparted with braking force by a hydraulic brake actuator 20. In addition to an electrical pump Po, the brake actuator 20 is provided with a retention valve Vk and a decompression valve Vr, for each of the wheels (the drive wheels 16 and the idler wheels 18). The retention valve Vk retains the pressure of the hydraulic oil supplied to a wheel cylinder 24, and the decompression valve Vr reduces the pressure of the hydraulic oil in the wheel cylinder 24. The brake actuator 20 is also provided with a linear relief valve Vf for causing pressure difference between the side of a master cylinder, not shown, and the side of the wheel cylinder 24. The discharge side of the pump Po is connected to the suction side of the pump Po via the retention valve Vk and the decompression valve Vr. The hydraulic oil is flowed in/out between the connected portion of the retention valve Vk and the decompression valve Vr, and the wheel cylinder 24.

The operation of the linear relief valve Vf, the retention valve Vk and the decompression valve Vr can realize automatic brake control which is performed independent of the user's brake operation which realizes anti-brake lock braking control (ABS), traction control and skid prevention control, for example. Specifically, in retaining braking force, the pressure of the hydraulic oil in the wheel cylinder 24 is retained by closing both of the retention valve Vk and the decompression valve Vr. In decreasing braking force, the pressure in the wheel cylinder 24 is lowered by closing the retention valve Vk and opening the decompression valve Vr.

In increasing braking force, the pressure of the hydraulic oil supplied to the wheel cylinder 24 is raised by opening the linear relief valve Vf and the retention valve Vk and closing the decompression valve Vr. In this case, the pressure in the wheel cylinder 24 is controlled by controlling the current supply for the linear relief valve Vf. Specifically, the linear relief valve Vf is adapted to cause pressure difference between the side of the master cylinder and the side of the wheel cylinder 24, as mentioned above, in proportion to the amount of current supply. Accordingly, the pressure difference can be adjusted according to the amount of current supply, which is eventually led to the pressure control in the wheel cylinder 24. In particular, in the case where the user's brake operation for realizing skid prevention control, for example, is not performed, the pump Po is actuated to produce a pressure to be applied into the wheel cylinder 24, while at the same time, the pressure is adjusted according to the amount of current supply to the linear relief valve Vf.

In this regard, hysteresis may be caused to the pressure difference between the side of the master cylinder and the side of the wheel cylinder 24, accompanying the increase and decrease in the amount of current supply mentioned above. In order to reduce the hysteresis, the operation of current supply to the linear relief valve Vf is so carried out based on time-ratio control for adjusting time ratio between logic “H” and logic “L” of applied voltage (the ratio of logic “H” to the time periods of logic “H” and logic “L”: duty). The frequency (dither frequency) of the time-ratio control ranges from about “1 kHz” to “several kHz's”, for example.

Each of the drive wheels 16 and the idler wheels 18 is provided with a wheel-speed sensor 26 for detecting the rotational speed of the wheel.

A control apparatus 30 controls the travel conditions of the vehicle. Specifically, the control apparatus 30 retrieves detection values of various sensors for detecting the operating conditions of the engine 10 and the automatic transmission system 14, as well as the output signals of the wheel-speed sensors 26, a user interface 32 and an acceleration sensor 34 to control traveling of the vehicle based on these values and signals. The user interface 32 includes an automatic travel switch through which the user can request automatic travel of the vehicle, and an accelerator operating member through which the user can request torque increase to the engine 10. The accelerator sensor 34 is adapted to detect acceleration based on the force applied to the sensor per se. The acceleration to be detected is acceleration caused in the longitudinal direction (i.e., the front-rear direction or the anteroposterior direction) of the vehicle. A pendulum type or strain-gauge type sensor, for example, can serve as the accelerator sensor 34.

When a request for automatic travel is inputted by the user through the user interface 32, the control apparatus 30 controls the actual speed (actual acceleration) of the vehicle to a target value (target acceleration). The details are provided below.

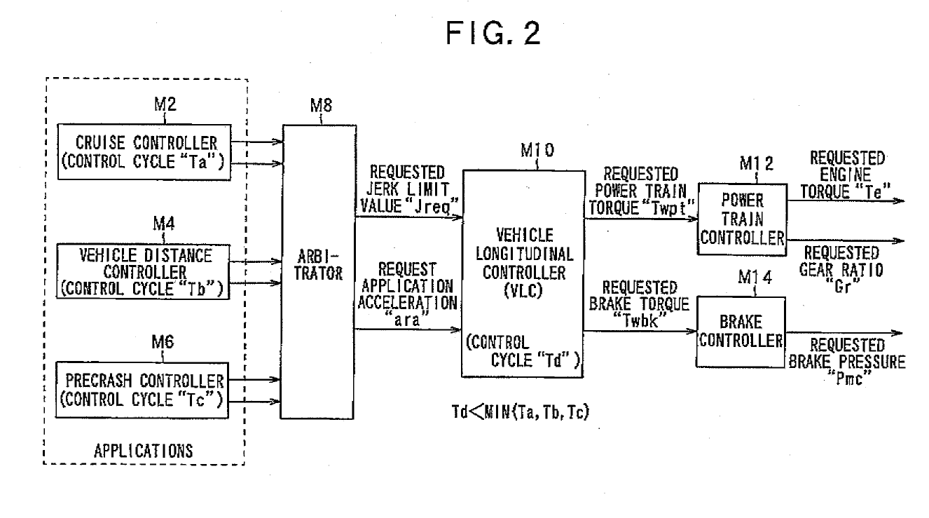

FIG. 2 shows the processes associated, in particular, with the automatic travel control, among the processes performed by the control apparatus 30.

FIG. 2 exemplifies such automatic travel applications as a cruise controller M2, a vehicle distance (intervehicle) controller M4 and a so precrash controller M6. The cruise controller M2 controls the travel speed of the vehicle to be kept at a certain level. The vehicle distance controller M4 controls the distance between the vehicle and a preceding vehicle to a predetermined distance. The precrash controller M6 controls the shock of possible collision with the preceding vehicle to be mitigated. The cruise controller M2, the vehicle distance controller M4 and the precrash controller M6 all output a requested value of acceleration (requested acceleration) and a requested limit value of jerk that will be described later.

An arbitrator M8 outputs a finally requested jerk limit value “Jreq” and a requested acceleration (application-based acceleration “ara”) based on the outputs from the cruise controller M2, the vehicle distance controller M4 and the precrash controller M6, which are provided as various applications for the control apparatus.

A vehicle longitudinal controller (VLC) M10 outputs: a requested power-train torque “Twpt” which is a torque requested for the power train comprising the engine 10 and the automatic transmission system 14; and a requested brake torque “Twbk” which is a torque requested for the brake actuator 20. A control cycle “Td” of the vehicle longitudinal controller M10 is different from a control cycle “Ta” of the cruise controller M2, a control cycle “Tb” of the vehicle distance controller M4 and a control cycle “Tc” of the precrash controller M6. Specifically, the cycle “Td” of the vehicle longitudinal controller M10 is set shorter than the cycle “Ta” of the cruise controller M2, the cycle “Tb” of the vehicle distance controller M4 and the cycle “Tc” of the precrash controller M6. This is because the applications are adapted to calculate requested acceleration based on various detection values obtained from detecting means, such as one which detects a preceding vehicle by radar, and thus because the detection cycles of these detecting means tend to be longer than the detection cycles of actual vehicle speed and actual acceleration.

A power train controller M12 outputs a requested value of torque so for the engine 10 (requested engine torque “Te”), and a requested value of gear ratio for the automatic transmission system 14 (requested gear ratio “Gr”), in response to the requested power train torque “Twpt”. A brake controller M14 outputs a requested value of hydraulic oil pressure for the brake actuator 20 (requested brake pressure “Pmc”), in response to the requested brake torque “Twbk”. It should be appreciated that the requested brake pressure “Pmc” is a manipulated variable of the brake actuator 20 which adjusts, through the hydraulic oil pressure, the braking force in each of the drive wheels 16 and the idler wheels 18.

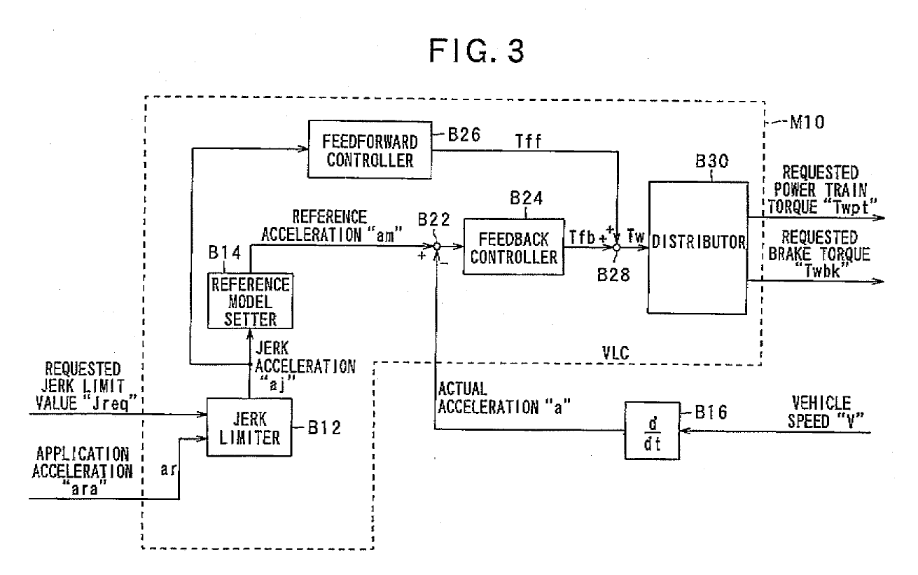

FIG. 3 shows in detail the processes performed by the vehicle longitudinal controller M10.

The front-rear direction controller M10 is configured to output the application acceleration “ara” outputted from the arbitrator M8 to the jerk limiter 812, as a requested acceleration “ar”. The jerk limiter B12 is configured to perform a process for limiting the amount of change in the requested acceleration value within one control cycle of the front-rear direction controller M10, to the requested jerk limit value “Jreq” or less.

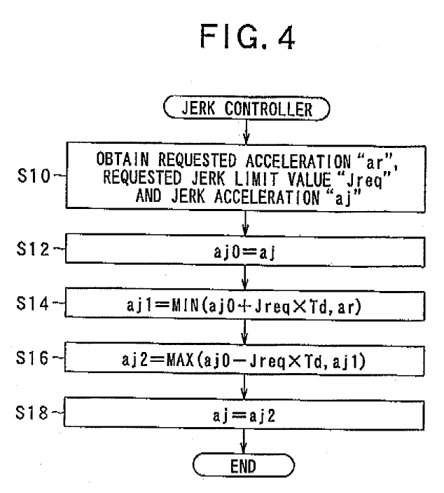

FIG. 4 shows a series of processes performed by the jerk limiter B12. First, at step S10, the jerk limiter B12 obtains the requested acceleration “ar”, the requested jerk limit value “Jreq” and a jerk acceleration “aj” that is the present output of the jerk limiter B12. At the subsequent step S12, the jerk acceleration “aj” is set as a previous value “aj0”. At steps S14 and S16, the change in the requested acceleration “ar” is limited so that the difference from the previous value “aj0” will be equal to or less than the jerk limit value “Jreq”. That is, at step S16, a value “aj1” is calculated, which value corresponds to a value obtained by multiplying the jerk limit value “Jreq” with the control cycle “Td” and adding the resultant value to the previous value “aj0”, or corresponds to the requested acceleration “ar”, whichever is smaller. At the subsequent step S16, a value “aj2” is calculated, which value corresponds to a value obtained by multiplying the jerk limit value “Jreq” with the control cycle “Td” and subtracting resultant value from the previous value “aj0,” or corresponds to the smaller value “aj1” mentioned above, whichever is larger. At step S18, the larger value “aj2” is set as the jerk acceleration “aj”.

Thus, in one control cycle of the applications, the jerk acceleration “aj” is shifted stepwise to the requested acceleration “ar” at every control cycle “Td” of the vehicle longitudinal controller M10, with the jerk limit value “Jreq” as being the maximum amount of change.

In the vehicle longitudinal controller M10, the vehicle acceleration is controlled to the jerk acceleration “aj” by two-degree freedom control. In particular, the actual acceleration is feedback-controlled to the jerk acceleration “aj”, and at the same time, the actual acceleration is feedforward controlled to the jerk acceleration “aj”. An explanation will be given first on the feedback control.

<Feedback Control>

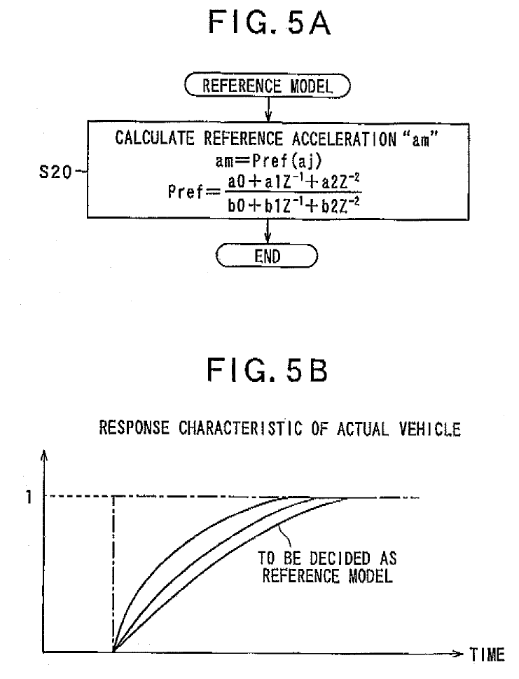

A reference model setter 8514 shown in FIG. 3 outputs a reference acceleration “am1” by converting the jerk acceleration “aj” in terms of a reference model. The reference model is to determine a behavior of the target acceleration in a transient travel time period of the vehicle, during which the jerk acceleration “aj” changes. The process performed by the reference model setter B14 is shown in FIG. 5A as step S20. Specifically, the reference model is a primary delay model, and thus the jerk acceleration “aj” is converted in terms of the primary delay model. As shown in FIG. 5B, the primary delay model is set based on the response characteristics at the time when the response delay of the actual acceleration (solid lines) is maximized, in a step change of the target acceleration (dash-dot line). More specifically, the response characteristics are supposed to change according to the operating conditions of the vehicle, such as the rotational speed of the engine 10. Thus, in the changing operating conditions, the characteristics at the time when the response delay is maximized are used as the base for the primary delay model.

A differential operator B16 shown in FIG. 3 performs an operation by differentiating an actual vehicle speed “V” with respect to time. The actual vehicle speed “V” is based on the detection value derived from the wheel-speed sensor 26 provided at each of the drive wheels 16 and the idler wheels 18. In particular, the actual vehicle speed “V” may, for example, be an average of the detection values of the four wheel-speed sensors 26, or a maximum value of the detection values.

A difference calculator B22 is configured to calculate the difference (difference “err”) between an actual acceleration “a” outputted from the differential operator B16 and the reference acceleration “am” outputted from the reference model setter B14.

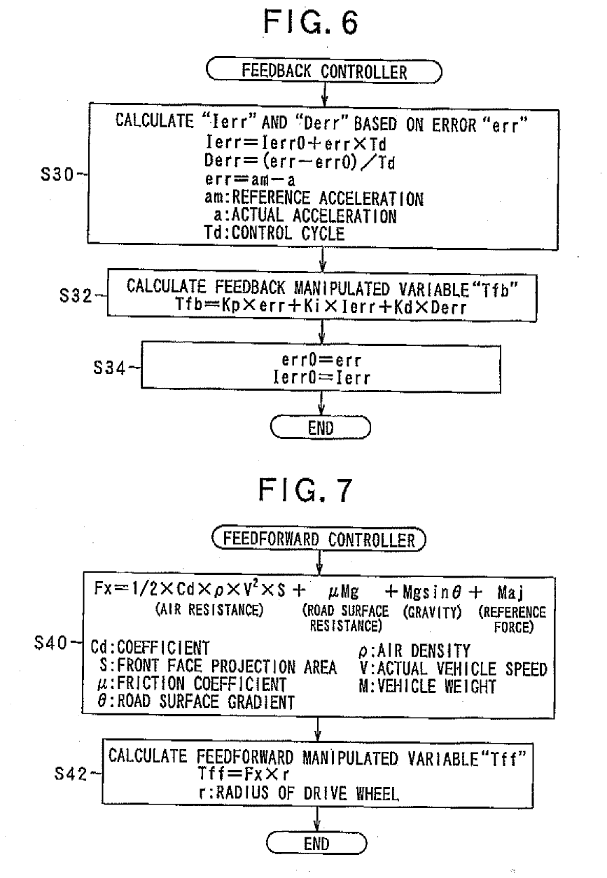

A feedback controller B24 is an element that feedback-controls the actual acceleration “a” to the reference acceleration “am”. Specifically, the feedback controller B24 of the present embodiment is configured to perform proportional-integral-differential (PID) control. FIG. 6 illustrates a series of procedure performed by the feedback controller 24.

First, at step S30, an integral value “Ierr” and a differential value “Derr” are calculated based on the difference “err”. Particularly, the current integral value “Ierr” is calculated by multiplying the current difference “err” with the control cycle “Td” and adding the resultant to a previous integral value “Ierr0”. Also, the differential value “Derr” is calculated by subtracting a previous difference “err0” from the current difference “err” and dividing the resultant by the control cycle “Td”. At the subsequent step S32, a feedback manipulated variable “Tfb” is calculated. Particularly, the feedback manipulated variable “Tfb” is calculated by summing up: a value obtained by multiplying the difference “err” with a proportional gain “Kp”; a value obtained by multiplying the integral value “Ierr” with an integral gain “Ki”; and a value obtained by multiplying the differential value “Derr” with a differential gain “Kd”. The proportional gain “Kp”, the integral gain “Ki” and the differential gain “Kd” are for converting the integral value “Ierr” so and the differential value “Derr” into the requested torque. In other words, the feedback manipulated variable “Tfb” represents a torque requested for rendering the actual acceleration “a” to be the reference acceleration “am”. When the process pf step S32 is completed, the difference “err” is stored, at step S34, as the previous difference “err0” and the integral value “Ierr” is stored as the previous integral value “Ierr0”.

<Feedforward Control>

Hereinafter is explained the feedforward control in the two-degree freedom control mentioned above.

A feedforward controller B26 shown in FIG. 3 performs the feedforward control to achieve the jerk acceleration “aj”. FIG. 7 shows a series of processes performed by the feedforward controller B26.

First, at step S40, a force “Fx” is calculated, which should be added to the travel direction of the vehicle to achieve the jerk acceleration “aj”. At this step, the force “Fx” is calculated as a sum of air resistance, road surface resistance, gravity and reference force. The reference force can be obtained by multiplying the jerk acceleration “aj” with a vehicle weight “M”. The reference force is necessary for having the vehicle traveled at the jerk acceleration “aj” in the state where no resistance is added in traveling the vehicle. The air resistance is a force of air, which is added in the direction reverse of the travel direction of the vehicle. In the present embodiment, the air resistance is calculated by multiplying the square of the actual vehicle speed “Vr” with an air density “ρ”, a coefficient “Cd” and a projection area “S” of the vehicle front, followed by multiplication with “½”. The road surface resistance is a resistance caused by the friction between the road surface and the drive wheels 16 and the idler wheels 18, and is calculated by the multiplication of a friction coefficient “μ”, the vehicle weight “M” and a gravity acceleration “g”. The term “gravity” refers to a gravity which is, applied to the travel direction of the vehicle when the road surface is inclined. This “gravity” can be expressed by “Mg sin θ” using a road so surface gradient “θ”. It should be appreciated that the road surface gradient “θ” is calculated based on the actual vehicle speed “V” and the detection value of the acceleration sensor 34 mentioned above.

At the subsequent step S42, a feedforward manipulated variable “Tff” is calculated by multiplying the force “Fx” with a radius “r” of the drive wheel 16. The feedforward manipulated variable “Tff” is the torque requested for having the vehicle traveled at the jerk acceleration “aj”.

An axle torque calculator B28 shown in FIG. 3 calculates a requested axle torque “Tw” by adding the feedback manipulated variable “Tfb” to the feedforward manipulated variable “Tff”.

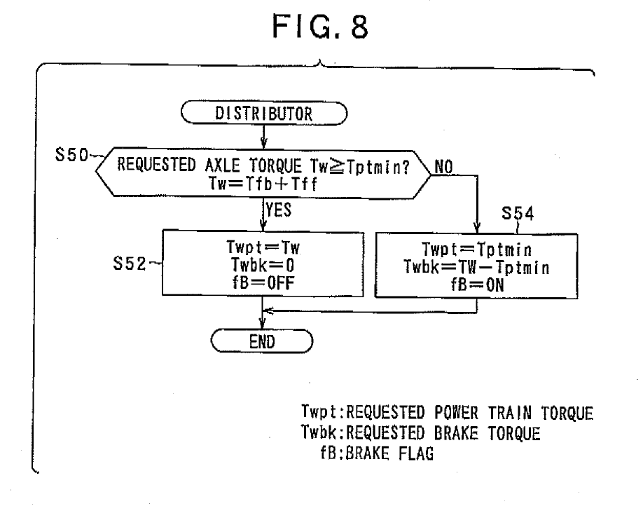

A distributor B30 divides (distributes) the requested axle torque “Tw” into the requested power train torque “Twpt” and the requested brake torque “Twbk”. FIG. 8 shows a series of processes performed by the distributor 530.

First, at step S50, it is determined whether or not the requested axle torque “Tw” is equal to or more than a minimal torque “Tptmin”. This process determines whether or not the requested axle torque “Tw” can be produced only by the power train. In this regard, the minimal torque “Tptmin” here is the minimal torque that is available by the engine 10 and the automatic transmission system 14. If the requested axle torque “Tw” is equal to or more than the minimal torque “Tptmin”, the requested axle torque “Tw” is determined as can be realized only by the power train, and control proceeds to step S52. At step S52, the requested power train torque “Twpt” is set as the requested axle torque “Tw”, while the requested brake torque “Twbk” is set to zero. On the other hand, if a negative determination is made at step S50, the requested axle torque “Tw” is determined as cannot be produced only by the power train, and control proceeds to step S54. At step S54, the requested power train torque “Twpt” is set as the minimal torque “Tptmin”, and the requested brake torque “Twbk” is set as a value obtained by subtracting the minimal torque “Tptmin” from the requested so axle torque “Tw”.

According to the series of processes described above, the actual acceleration of the vehicle can be controlled to the jerk acceleration “aj”. In the case where the jerk acceleration “aj” changes, the actual acceleration can be properly controlled to the reference acceleration “am”. In other words, in the case where the jerk acceleration “aj” changes and where the acceleration of the vehicle is feedforward controlled to the jerk acceleration “aj”, response delay is caused in the actual acceleration with respect to the change in the jerk acceleration “aj”, due to the response delay of the vehicle. However, the actual acceleration estimated from the response delay can be approximated to the reference acceleration “am”. In addition, owing to the feedback control, the actual acceleration can be controlled to the reference acceleration “am” with high accuracy.

The accuracy of the feedforward control described above resultantly relies, for example, on the accuracy of estimating the road surface gradient “θ”. In particular, when the accuracy of estimating the road surface gradient “θ” is low, the accuracy may be deteriorated in estimating the torque required for controlling the actual acceleration to the jerk acceleration “aj”, which may eventually be led to the deterioration in the feedforward controllability. In estimating a road surface gradient, the influence of noises superposed on the detection value of the acceleration sensor 34 and on the differential value of the actual vehicle speed “V” are unignorable. To cope with this, the road surface gradient is estimated through the following procedure in the present embodiment.

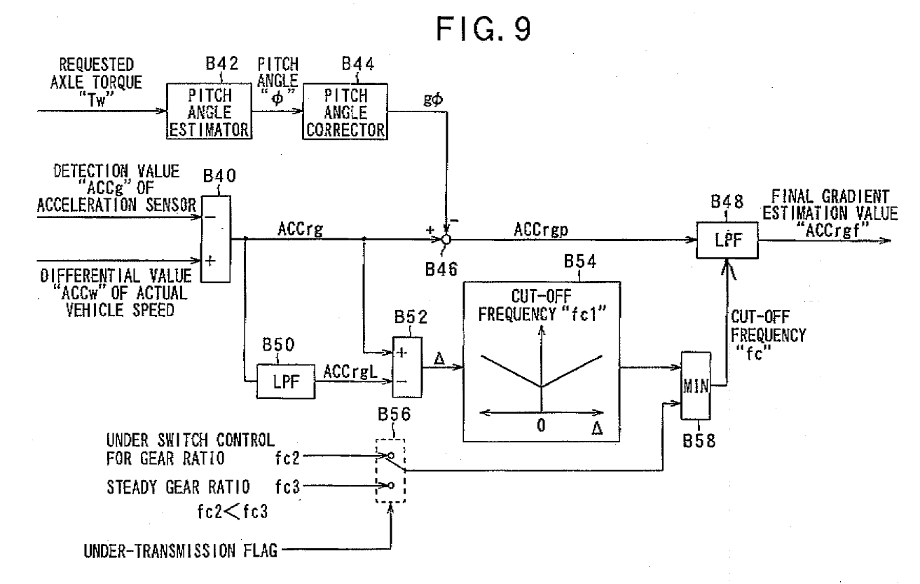

FIG. 9 is a block diagram illustrating the procedure for estimating road surface gradient according to the present embodiment.

A first road surface gradient estimator 840 is configured to calculate and output a first estimation value “ACCrg” as a difference between a detection value “ACCg” of the acceleration sensor 34 and a differential value “ACCw” of the actual vehicle speed “V”. The difference between the detection value “ACCg” and the differential value “ACCw” is inherently expressed using the road surface gradient “θ” as “g·sin θ”. However, when the road surface gradient “θ” is small, the difference can be expressed by “g·θ”. Accordingly, the difference between the detection value “ACCg” and the differential value “ACCw” almost equals to a constant multiplication of the road surface gradient (g-fold of the gravitational acceleration).

A pitch angle estimator B42 is configured to estimate the amount of rotation in the direction of the rotation angle (pitch angle “φ”) of the lateral axis of the vehicle, based on the requested axle torque “Tw”. This estimation is carried out considering that the vehicle tilts rearward (squats) when the vehicle is accelerated, and the vehicle tilts forward (dives) when the vehicle is decelerated. Specifically, the pitch angle “φ” is considered to be no longer zero during the acceleration or deceleration of a vehicle, and hence the pitch angle “φ” can be estimated based on the torque generated by the actuators (the power train and the brake actuator 20). For this reason, the pitch angle “φ” is estimated based on the requested axle torque “Tw”. More specifically, considering that there is a delay for the actual vehicle pitch angle to responsively change according to the axle torque “Tw”, the pitch angle “φ” is estimated, in the present embodiment, using the following primary delay model.

φ=Tw·Kpit/(Tpit·s+1)

where “Kpit” is a pitch angle gain, and “Tpit” is a time constant.

A pitch angle corrector B44 is configured to calculate a correction amount for correcting the first estimation value “ACCrg”, based on the pitch angle “φ”. Since the acceleration sensor 34 tilts in response to the pitch angle “φ” of the vehicle, the correction is made considering that, of the acceleration factors sensed by the acceleration sensor 34, those which are induced by the gravity will be expressed by “g sin (θ+φ)”. Considering that the first estimation value “ACCrg” here corresponds to “g·θ”, the correction amount is set to be “g·φ”.

A gradient corrector B46 is configured to calculate and output a second estimation value “ACCrgp” by correcting the output of the first road surface gradient estimator B40 using the output of the pitch angle corrector 644. In particular, the gradient corrector B46 subtracts the correction amount “g·φ” from the first estimation value “ACCrg”, that is, corrects the first estimation amount “ACCrg” using the correction amount “g·φ”, to calculate and output the second estimation value “ACCrgp”. As a result, the second estimation value “ACCrgp” will be appropriately compensated for the influence of the “squatting” and “diving” of the vehicle on the detection value “ACCg” of the acceleration sensor 34.

A lowpass filter B48 is configured to selectively permeate low-frequency components of the second estimation value “ACCrgp” to output a final gradient estimation value “ACCrgf”. Particularly, the lowpass filter B48 is made up of a primary delay filter. More particularly, the lowpass filter B48 is made up of a filter that uses cut-off frequency “fc” and can be expressed by “1/{1/(2πfc)s+1}”. The cut-off frequency “fc” can be variably set through the processes explained below.

A lowpass Filter B50 is configured to perform a filtering process of permeating low-frequency components of the first estimation value “ACCrg” to thereby output a delay estimation value “ACCrgL”. The delay estimation value “ACCrgL” expresses the road surface gradient, but when the road surface gradient changes, will be a signal delayed from the first estimation value “ACCrg”, the delay being caused by the filtering process.

A gradient change estimator 52B is configured to calculate and output an estimation value of an amount of change in the road surface gradient (gradient change estimation value “Δ”) in terms of a difference between the delay estimation value “ACCrgL” and the first estimation value “ACCrg”. In particular, it is considered that the larger the change in the road surface gradient is, the more the delay estimation value “ACCrgL” is delayed from the first estimation value “ACCrg”. Focusing on this point, the gradient change estimator 52B is adapted to quantify the difference between these values as a gradient change estimation value “Δ”.

A first frequency setter B54 is configured to set a cut-off frequency “fc1” for determining the cut-off frequency “fc” for the filtering process performed by the lowpass filter B48. In particular, the cut-off frequency “fc1” is set to a higher value as the gradient change estimation value “Δ” becomes larger. This is because, if there is a change in the road surface gradient, the delay in the final gradient estimation value “ACCrgf” is likely to be the cause of trouble, which delay is ascribed to the delay effects of the filtering process performed by the lowpass filter B48. Specifically, considering that the amount of delay is increased as the cut-off frequency “fc” is decreased, the first frequency setter B54 is configured to set the cut-off frequency “fc1” to a higher value, as the delay in the final gradient estimation value “ACCrgf” from the actual gradient is more likely to be the cause of trouble. In other words, a higher value is set for the cut-off frequency “fc1” as the change in the gradient becomes larger.

On the other hand, when the change in the road surface gradient is small, the amount of delay in the final estimation value “ACCrgf” from the actual gradient is unlikely to be the cause of trouble. In this case, it is the noises, not the delay in the final gradient estimation value, that are considered to give a larger influence to the estimation accuracy of the road surface gradient, which noises are superposed on the detection value “ACCg” of the acceleration sensor 34 and the differential value “ACCw” of the actual vehicle speed “V”. For this reason, the cut-off frequency is decreased as the change in the road surface gradient becomes smaller. In this way, the present embodiment provides a filtering process which establishes a trade-off relationship between the noise removal effects and the responsiveness. Specifically, the present embodiment is so configured to variably set the cut-off frequency according to the change in the road surface gradient, and, from hence, to apply an optimal filtering process depending on the degree of contribution of either the noise removal effects or the responsiveness, whichever is larger, to the estimation accuracy of the road surface gradient.

A second frequency setter B56 is configured to switch the cut-off frequency for the filtering process performed by the lowpass filter B48, depending on whether or not the automatic transmission system 14 is in the process of effecting switch control for gear ratio. This configuration is based on an idea that, with the switch control for gear ratio, transmission shock is caused, which in turn will trigger the entry of the noises into the detection value “ACCg” of the acceleration sensor 34, for example. The transmission shock is caused, for example, when transmission of the torque is stopped from the crank shaft 12 of the engine 10 to the drive wheels 16 through the automatic transmission system 14, or when the conditions of engagement are changed between friction elements, such as the clutch C in the automatic transmission system 14 and the brake. In particular, a cut-off frequency “fc2” under switch control for gear ratio is set lower than a cut-off frequency “fc3” in a steady state where no control is effected for gear ratio. This setting is purposed to enhance the filtering effects and thus to suppress the influence of the noises which are caused in effecting the switch control for gear ratio.

A frequency determining section B58 is configured to determine the cut-off frequency “fc” for the lowpass filter 548, based on the output from the first frequency setter B54 and the output from the second frequency setter B56. In particular, the output value of either the first or second frequency setter B54 or 556, whichever is smaller, is set as the final cut-off frequency “fc” and outputted to the lowpass filter B48. The cut-off frequency “fc3” in the steady state where no switch control is effected for gear ratio, is set to a value equal to or more than the maximum value of the cut-off frequency “fc” of the first frequency setter B54. This setting is purposed to employ the cut-off frequency “fc1” outputted from the first frequency setter B54, as the final cut-off frequency “fc”, unless the switch control is being effected for gear ratio. It should be appreciated that the minimum value of the cut-off frequency “fc1” should have been set to an appropriate value by the first frequency setter B54, in the case where there is no change in the road surface gradient and no switch control is effected for gear ratio. In other words, the minimum value of the cut-off frequency “fc1” should have been set to a value larger than the cut-off frequency “fc2” used during the switch control of the gear ratio.

With the process explained above, the influence of the squatting or diving of the vehicle on the detection value “ACCg” of the acceleration sensor 34 can be compensated by the pitch angle correction amount “g·φ”. Also, in order to suppress the influence of the vibration transmitted to the vehicle, the process of the lowpass filter B48 is carried out, with the cut-off frequency for the filter being variably set depending on whether or not the road surface gradient has changed or whether or not the switch control for gear ratio has been conducted. Thus, the gradient estimation value “ACCrgf” can be calculated as accurately as possible according to the operating conditions of the vehicle. In this way, high accuracy can be expected in the calculation of the feedforward manipulated variable “Tff”, which may further be led to the high-accuracy control of the acceleration of the vehicle. It should be appreciated that the gradient estimation value “ACCrgf” corresponds to “g sin θ” in the term “Mg sin θ” at step S40 shown in FIG. 7.

The present embodiment described above in detail may provide the advantages as provided below.

(1) The second estimation value “ACCrgp” based on the detection value “ACCg” of the acceleration sensor 34 and the differential value “ACCw” of the actual vehicle speed “V” has been subjected to filtering process of the lowpass filter B48 to calculate the gradient estimation value “ACCrgf”. In the calculation, the cut-off frequency “fc” for the so filtering process has been variably set according to the operating conditions of the vehicle. Thus, the gradient estimation value “ACCrgf” can be calculated with high accuracy in any operating conditions.

(2) The cut-off frequency “fc” of the lowpass filter 548 has been variably set based on the information on the change in the road surface gradient, which is outputted from the gradient change estimator B52. Thus, when the responsiveness in the estimation of the road surface gradient is desired to be enhanced in spite of the changing road surface gradient, the responsiveness can be enhanced by increasing the cut-off frequency “fc”.

(3) The gradient change has been estimated based on the difference between the first estimation value “ACCrg” and the delay estimation value “ACCrgL” resulting from the filtration of the first estimation value “ACCrg”. Thus, the change in the road surface gradient can be appropriately estimated.

(4) Under the switch control for gear ratio, the cut-off frequency “fc” has been decreased. Thus, the influence quantity of the transmission shock in the estimation of the road surface gradient can be appropriately suppressed.

(5) The pitch angle “φ”, i.e. the rotation angler of the lateral axis of the vehicle has been estimated. Then, the estimated road surface gradient (first estimation value “ACCrg”) has been corrected based on the estimated pitch angle “φ”. Thus, the influence of the pitch angle “φ” can be appropriately removed from the estimation of the road surface gradient.

(6) The actual acceleration of the vehicle has been subjected to feedforward control according to the requested acceleration (jerk acceleration “aj”), based on the gradient estimation value “ACCrgf”. Thus, the feedforward control can be appropriately performed. As a result, the travel conditions of the vehicle, as well as the ride quality can be improved.

(Modifications)

The embodiment described above can be modified as follows.

Under the switch control for gear ratio, the above embodiment has given priority to the removal of noises accompanying the transmission shock, over the enhancement of the responsiveness for the change in the road surface gradient. Alternatively, in the case where the change in the road surface gradient is more than a predetermined level, the cut-off frequency “fc1” may be employed as the final cut-off frequency “fc”, irrespective of whether or not the switch control for gear ratio is performed.

The above embodiment has estimated the pitch angle “φ” using the primary delay model by inputting the requested axle torque “Tw”. Alternatively, for example, a secondary delay model may be used.

The above embodiment has employed the first estimation value “ACCrg” as the difference between the detection value “ACCg” and the differential value “ACCw” of the actual vehicle speed. Alternatively, considering that the above difference corresponds, to be exact, to “g·sin θ”, the first estimation value “ACCrg” may be the value expressed by “arcsin {(difference)/g}”. Also, the first estimation value “ACCrg” may be the value obtained by dividing the above difference with a gravitational acceleration “g”. In any case, the pitch angle correction amount in such a case may desirably be the pitch angle “(p”.

The lowpass filters B48 and B50 are not limited to primary delay filters, but Butterworth filters may alternatively be used.

The lowpass filter B48 to which the cut-off frequency is variably set may be applied to at least one of the detection value “ACCg” of the acceleration sensor and the differential value “ACCw” of the actual vehicle speed “V”, instead of applying to the second estimation value “ACCrgp”.

The above embodiment has estimated the road surface gradient based on the detection value “ACCg” of the acceleration sensor and the differential value “ACCw” of the actual vehicle speed “V”. Alternatively, for example, the road surface gradient may be estimated based on the differential value “ACCw” of the actual vehicle speed “V” and the acceleration estimated from the torque (requested axle torque “Tw”) generated by the actuators of the vehicle. Alternatively, the road surface gradient may be estimated based on the detection value “ACCg” of the acceleration sensor and the torque (requested axle torque “Tw”) generated by the actuators of the vehicle.

The above embodiment has estimated the pitch angle rain from the requested axle torque “Tw”. Alternatively, for example, the pitch angle “φ” may be estimated from the differential value “ACCw” of the actual vehicle speed.

In the embodiment described above, the reference model has been set based on the response characteristics at the time when the response delay of the actual acceleration is maximized with respect to the step change of the target acceleration. Alternatively, for example, the reference model may be variably set according to the response characteristics for every operating condition of the vehicle. Also, the reference model is not limited to the primary delay mode, but may, for example, be a secondary delay model.

The feedback controller B24 is not limited to the one that performs PID (proportional-integral-differential) control, but may be the one that performs either one of or any two of P control, I control and D control. Alternatively, modern control may be used instead of classical control.

The feedforward controller B26 is not limited to the one that performs the processes described above. The feedforward controller B26 may calculate the feedforward manipulated variable “Tff” only from the reference force “Maj”, for example. Also, the feedforward manipulated variable “Tff” may be calculated using either one of or any two of the air resistance, the road surface resistance and the gravity.

In the embodiment described above, the two-degree freedom control has been performed. Alternatively, for example, only feedforward control may be performed.

In the embodiment described above, the model follow-up control so has been performed. Alternative to this, the reference model setter B14 may not be furnished.

In the acceleration control in the embodiment described above, the means for imparting positive torque to the vehicle (more particularly the drive wheels 16 of the vehicle) has been exemplified by the power train, i.e. motive power generator, including the engine 10 and the automatic transmission system 14. Alternatively, however, a motor may be used, for example, as the motive power generator. Also, the automatic transmission system 14 may not necessarily be the one having a planetary gear automatic transmission, but may, for example, be the one having a continuously variable transmission (CVT) which is able to adjust the gear ratio in a continuous manner.

In the acceleration control in the embodiment described above, the means for imparting negative torque to the vehicle (more particularly the drive wheels 16 of the vehicle) has been exemplified by the hydraulic brake actuator. Alternatively, however, a generator may be used, for example, which converts the torque of wheels (drive wheels 16 and the idler wheels 18) into electric energy.

The apparatus for estimating road surface gradient may not necessarily be applied to the front-rear direction controller M10. Also, the apparatus for estimating road surface gradient may not necessarily be applied to a vehicle control system equipped with the front-rear direction controller M10.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. An apparatus for estimating a gradient of a road surface on which a vehicle travels, comprising:
acquisition means for acquiring at least one of acceleration of the vehicle calculated on changes in a travel speed of the vehicle and acceleration sensed from a force applied to the vehicle;
estimation means for estimating the gradient of the road surface based on the acceleration acquired by the acquisition means; and
compensation means for compensating the acceleration acquired by the acquisition means in terms of influence of noise superposed on the acceleration, depending on an operational condition of the vehicle, the compensated acceleration being provided to the estimation means.

2. The apparatus of claim 1, wherein the acquisition means comprises at least one of calculation means for calculating the acceleration of the vehicle based on the changes in the travel speed of the vehicle and means for sensing the acceleration based on the force applied to the vehicle.

3. The apparatus of claim 2, wherein the compensation means comprises
filtering means for cutting off at least one of the noise superposed in the acceleration provided to the estimation means and the noise superposed in a signal used by the estimation means, the signal being related to the acceleration provided to the estimation means, the filtering means having a plurality of filtering modes selectably set, and
changing means for changing the filtering modes of the filtering means depending on the operational condition of the vehicle.

4. The apparatus of claim 3, further comprising
amount calculating means for calculating an amount corresponding to the gradient based on the acceleration provided by the acquisition means; and
provisional estimation means for provisionally estimating, as the operational condition of the vehicle, changes in the gradient of the road surface based on the amount calculated by the amount calculating means,
wherein the changing means the filtering modes of the filtering means depending on the changes in the gradient provisionally estimated by the provisional estimation means.

5. The apparatus of claim 4, wherein the provisional estimation means comprises filtering means for filtering the amount from the amount calculating means and means for estimating the changes in the gradient based on a difference between a filtered result of the amount by the filtering means and the amount from the amount calculating means.

6. The apparatus of claim 3, wherein the vehicle comprises a motive power generation apparatus having an output shaft transmitting a motive power and a staged transmission apparatus, whose gear ratios are switchable, transmitting the motive power from the output shaft to drive wheels of the vehicle, and
the changing means is configured to lower an upper limit of a cutting-off frequency of the filtering during a switchover control of the gear ratios at the stated transmission apparatus.

7. The apparatus of claim 3, wherein the acquisition means comprises at least the means for sensing the acceleration based on the force applied to the vehicle and the vehicle comprise a motive power generation apparatus that generates a motive power for the travel thereof.
further comprising
means for estimating a pitch angle of a pitch motion of the vehicle based on torque generated by the motive power generation apparatus, and
means for correcting the gradient of the road surface based on the estimated pitch angle.

8. An apparatus for estimating a gradient of a road surface on which a vehicle travels, the vehicle being provided with a motive power generation apparatus generating torque for the travel, comprising:
sensing means for sensing acceleration based on a force applied to the vehicle;
pitch angle estimation means for estimating a pitch angle of the vehicle based on the torque generated by the motive power generation apparatus;
gradient estimation means for estimating the gradient of the road surface based on the acceleration sensed by the sensing means and the pitch angle estimated by the pitch angle estimation means; and
correction means for correcting the gradient of the road surface estimated by the gradient estimation means.

9. An apparatus for controlling acceleration of a vehicle which travels on a road surface, comprising:
acquisition means for acquiring at least one of acceleration of a vehicle calculated on changes in a travel speed of the vehicle and acceleration sensed from a force applied to the vehicle;
estimation means for estimating a gradient of the road surface based on the acceleration acquired by the acquisition means;
compensation means for compensating the acceleration acquired by the acquisition means in terms of influence of noise superposed on the acceleration, depending on an operational condition of the vehicle, the compensated acceleration being provided to the estimation means; and
feedforward control means for feedforward controlling the acceleration of the vehicle based on a target acceleration and the gradient of the road surface estimated by the estimation means.

10. The apparatus of claim 9, further comprising an actuator to be actuated by the feedforward control means for the feedforward control.

11. The apparatus of claim 10, wherein the acquisition means comprises at least one of calculation means for calculating the acceleration of the vehicle based on the changes in the travel speed of the vehicle and means for sensing the acceleration based on the force applied to the vehicle.

12. The apparatus of claim 11, wherein the compensation means comprises
filtering means for cutting off at least one of the noise superposed in the acceleration provided to the estimation means and the noise superposed in a signal used by the estimation means, the signal being related to the acceleration provided to the estimation means, the filtering means having a plurality of filtering modes selectably set, and
changing means for changing the filtering modes of the filtering means depending on the operational condition of the vehicle.

13. The apparatus of claim 11, further comprising
amount calculating means for calculating an amount corresponding to the gradient based on the acceleration provided by the acquisition means; and
provisional estimation means for provisionally estimating, as the operational condition of the vehicle, changes in the gradient of the road surface based on the amount calculated by the amount calculating means,
wherein the changing means the filtering modes of the filtering means depending on the changes in the gradient provisionally estimated by the provisional estimation means.
